(19) United States
(12) Patent Application Publication
(10) Pub. No.: US 2015/0139339 A1
(43) Pub. Date: May 21, 2015

(54) BROADCAST TRANSMITTING APPARATUS AND METHOD

(71) Applicant: Electronics and Telecommunications Research Institute, Daejeon (KR)

(72) Inventors: Sang-Jung RA, Daejeon (KR); Joon Young JUNG, Daejeon (KR); Jae-Ho LEE, Daejeon (KR); Dong Joon CHOI, Daejeon (KR); Namho HUR, Daejeon (KR)

(21) Appl. No.: 14/308,779

(22) Filed: Jun. 19, 2014

(30) Foreign Application Priority Data
Nov. 21, 2013 (KR) 10-2013-0142390

(51) Int. Cl. H04N 19/85; H04N 19/89

(52) U.S. Cl. CPC H04N 19/00903; H04N 19/00933
USPC 375/240.27; 375/240.26

(57) ABSTRACT

A broadcasting transmitting apparatus splits a piece of broadcast content into an audio signal and a video signal, encodes the audio signal to generate an audio bit string, encodes the video signal to generate a video bit string, multiplexes the audio bit string and the video bit string, and modulates the multiplexed bit strings into a symbol. The encoded audio bit string is allocated to some bits of the symbol, and the encoded audio bit string is allocated to the remaining bits of the symbol.

### CROSS-REFERENCE TO RELATED APPLICATION

This application claims priority to and the benefit of Korean Patent Application No. 10-201 3-01 42390 filed in the Korean Intellectual Property Office on Nov. 21, 2013, the entire contents of which are incorporated herein by reference.

### BACKGROUND OF THE INVENTION

(a) Field of the Invention

The present invention relates to a broadcast transmitting apparatus and method, and more particularly, to a broadcast transmitting apparatus and method which take a user's viewing environment into consideration.

(b) Description of the Related Art

Nowadays, broadcasting and multicasting services have been popularized in such a way that they deliver multimedia applications to mobile equipment, as is the case with mobile TV services, as well as making stationary reception available.

However, current broadcasting services are disadvantageous in that video and audio signals are not properly received if the intensity of received signals is low, thus failing to receive the broadcasting services.

This leads to a demand for a method that enables a user to receive a broadcasting service even when the intensity of received signals is low.

### SUMMARY OF THE INVENTION

The present invention has been made in an effort to provide a broadcast transmitting apparatus and method which provide broadcasting service by taking a user's viewing environment into consideration.

An exemplary embodiment of the present invention provides a broadcast transmitting method for a broadcast transmitting apparatus. The broadcast transmitting method includes: splitting a piece of broadcast content into an audio signal and a video signal; encoding the audio signal and the video signal to generate an audio bit string and a video bit string; multiplexing the video bit string and the audio bit string; and modulating the multiplexed bit strings into a symbol, wherein some bits of the symbol include the audio bit string, and the remaining bits of the symbol include the video bit string.

The some bits may include the most significant bit and at least one bit after the most significant bit.

A signal allocated to each bit in the symbol may be determined depending on the characteristics of the symbol.

The characteristics may include error probability.

The encoding may include encoding the audio bit string at a lower encoding rate than that of the video bit string.

Another exemplary embodiment of the present invention provides a broadcast transmitting apparatus. The broadcasting transmitting apparatus includes a splitter, an audio encoder, a video encoder, a multiplexer, and a modulator. The splitter splits a piece of broadcast content into an audio signal and a video signal. The audio encoder encodes the audio signal to generate an audio bit string. The video encoder encodes the video signal to generate a video bit string. The multiplexer multiplexes the audio bit string and the video bit string. The modulator modulates the multiplexed bit strings into a symbol. The modulator allocates the encoded audio bit string to some bits of the symbol and allocates the encoded audio bit string to the remaining bits of the symbol.

The some bits may include the most significant bit, and the remaining bits may include the least significant bit.

The some bits may have lower error probability than the remaining bits.

The audio encoder may encode the audio signal at a lower encoding rate than that for the video encoder.

### BRIEF DESCRIPTION OF THE DRAWINGS

FIG. 1 is a view showing a broadcast transmitting apparatus according to an exemplary embodiment of the present invention.

FIG. 2 is a flowchart showing a broadcast transmitting method according to an exemplary embodiment of the present invention.

FIG. 3 is a view showing bits constituting a symbol.

FIG. 4 is a view showing a method for a modulator to allocate bits per symbol according to an exemplary embodiment of the present invention.

FIG. 5 is a view showing a broadcast receiving apparatus according to an exemplary embodiment of the present invention.

FIG. 6 is a view showing a broadcast receiving method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and the claims, unless explicitly described to the contrary, the word “comprise” and variations such as “comprises” or “comprising” will be understood to imply the inclusion of stated elements but not the exclusion of any other elements.

Now, a broadcast transmitting apparatus and method according to an exemplary embodiment of the present invention will be described in detail with reference to the drawings.

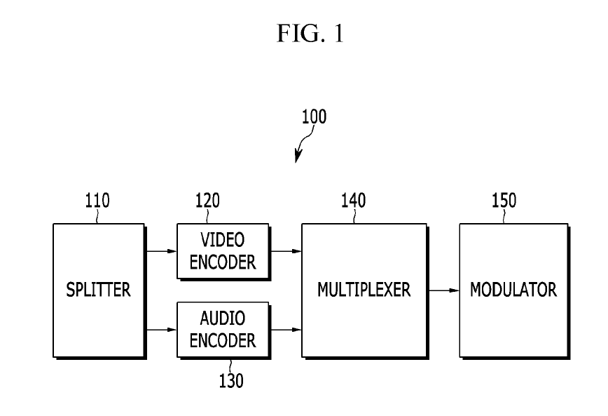

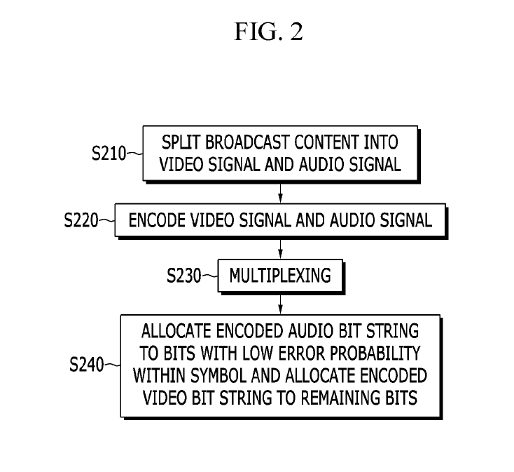

FIG. 1 is a view showing a broadcast transmitting apparatus according to an exemplary embodiment of the present invention, and FIG. 2 is a flowchart showing a broadcast transmitting method according to an exemplary embodiment of the present invention.

Referring to FIG. 1, the broadcasting transmitting apparatus 100 includes a splitter 110, a video encoder 120, an audio encoder 130, a multiplexer 140, and a modulator 150.

Referring to FIG. 2, the splitter 110 splits desired broadcast content into a video signal and an audio signal (S210). The split video and audio signals are input into the video encoder 120 and the audio encoder 130, respectively.

The video encoder 120 encodes a video signal to generate a video bit string, and the audio encoder 130 encodes an audio signal to generate an audio bit string (S220). The video encoder 120 and the audio encoder 130 can encode a video signal and an audio signal in the same encoding mode. Also, the audio encoder 130 may be of a lower order than the video encoder 120. That is, the audio encoder 130 can encode an audio signal at a lower encoding rate than that of the video encoder 120.

The multiplexer 140 multiplexes the encoded video bit string and the encoded audio bit string to generate a single transmission stream (S230).

The modulator 150 modulates the transmission stream into a symbol by a set modulation scheme. The modulator 150 allocates the encoded video bit string and the encoded audio bit string to bits in the symbol. That is, the modulator 150 allocates the encoded audio signal to bits with low error probability within a symbol and the encoded video signal to the remaining bits, that is, bits with high error probability, within the symbol (S240). For example, in a 64 QAM (Quadrature Amplitude Modulation) scheme, one symbol consists of 6 bits. In this case, the encoded audio signal may be allocated to the two most significant bits with low error probability, and the encoded video signal may be allocated to the four least significant bits with high error probability. That is, in 64 QAM, a 6-bit value is mapped to each symbol. Accordingly, the modulator 150 performs symbol mapping on the encoded audio bit string by using a specific number of most significant bits in each symbol, and performs symbol mapping on the encoded video bit string by using a specific number of least significant bits in each symbol. For example, encoded audio bits 00 may be mapped to one of 16 symbols whose two most significant bits are 00, and encoded video bits 0000 may be mapped to a symbol whose four least significant bits are 0000.

In this way, the broadcast transmitting apparatus 100 according to an exemplary embodiment of the present invention allocates a video signal to bits with high error probability within one symbol and an audio signal to bits with low error probability within a symbol. By doing so, audio signals can be demodulated properly even if the reception environment of the broadcast transmitting apparatus is not good.

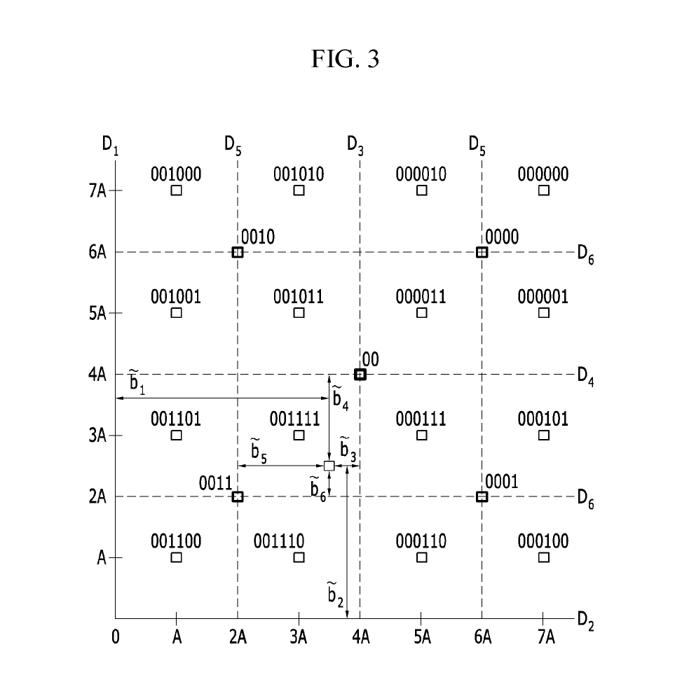

FIG. 3 is a view showing bits constituting a symbol, which depicts the positions of bits in one quarter of a QAM symbol according to a QAM modulation scheme.

Referring to FIG. 3, if the QAM symbol consists of 2 bits, the error probability is the same, i.e., 4 QAM, within the decision boundary D₁-D₂.

If the QAM symbol consists of 4 bits, the error probability is the same, i.e., 16 QAM, within the decision boundary D₁-D₂ and the decision boundary D₃-D₄, both having the error probability of 4 QAM.

Likewise, if the QAM symbol consists of 6 bits, the error probability is the same, i.e., 64 QAM, within the decision boundary D₁-D₆ because the decision boundary D₅-D₆ of 4 QAM is added.

The error probability for 64 QAM is lower than the error probability for 16 QAM, and the error probability for 16 QAM is lower than the error probability for 4 QAM.

Assuming that a received signal is r and a 64 QAM symbol is transmitted, the 2 most significant bits of the 64 QAM symbol are determined according to bit information [symbol] and [symbol] required for determination. Also, the third and fourth bits are determined according to bit information [symbol] and [symbol] required for determination, and the 2 least significant bits are determined according to [symbol] and [symbol] .

Here, [symbol] =Real(r) and [symbol] =Imag(r), which represent the real and imaginary values of the received signal r. Also, [symbol] =| [symbol] |−4A, [symbol] =| [symbol] |−4A, [symbol] =| [symbol] |−2A, and [symbol] =| [symbol] |−2A.

In this way, a broadcast receiving apparatus demodulates a received signal.

For 64 QAM, one symbol consists of 6 bits. The 2 most significant bits of one symbol have a lower error probability than the 4 least significant bits. For 16 QAM, one symbol consists of 4 bits. The 2 most significant bits of one symbol likewise have a lower error probability than the 2 least significant bits.

Accordingly, the modulator 150 according to the exemplary embodiment of the present invention allows for proper demodulation of audio signals to make them robust to the reception environment by allocating an encoded audio signal to bits with low error probability within a symbol.

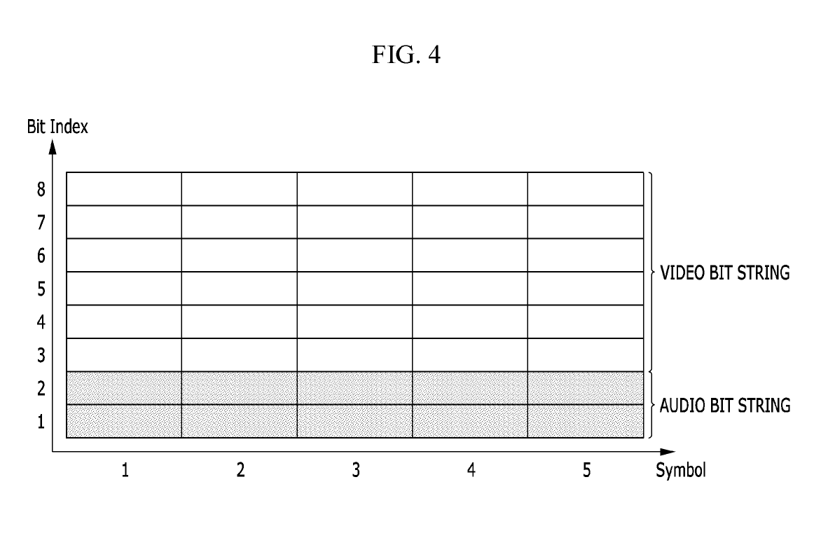

FIG. 4 is a view showing a method for a modulator to allocate bits per symbol according to an exemplary embodiment of the present invention.

Referring to FIG. 4, when the modulator 150 modulates a transmission stream into a symbol by a 256 QAM modulation scheme, the symbol consists of 8 bits. An audio bit string is allocated to the first and second bits (two most significant bits) with low error probability, among the 8 bits of each symbol, and a video bit string is allocated to the remaining bits.

If the intensity of a received signal is normal, the broadcast receiving apparatus can demodulate a video signal and an audio signal, thus enabling the user to properly view the broadcast. However, if the intensity of a received signal decreases and the signal is not properly received, bits with high error probability within a symbol cannot be properly demodulated and the video signal therefore may not be properly processed. On the other hand, bits with low error probability within the symbol are properly demodulated and the audio signal is therefore properly processed and received.

That is, audio signals can be properly received even when the reception environment of the broadcast receiving apparatus is not good.

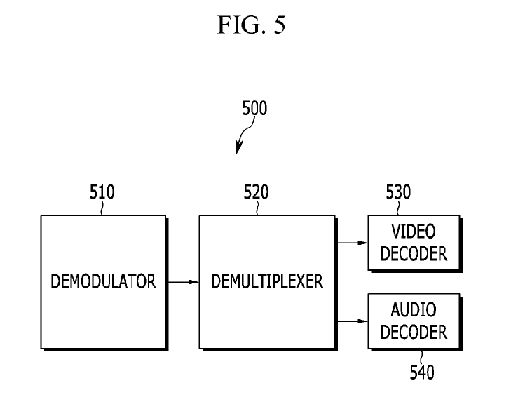

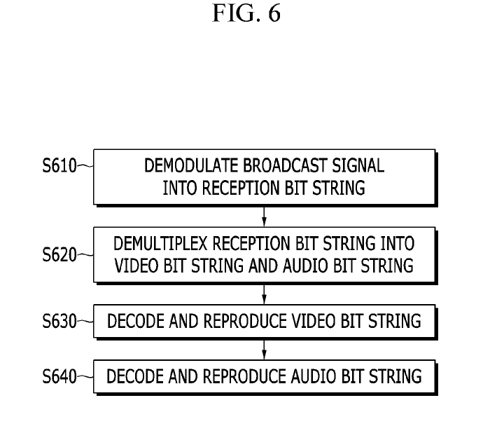

FIG. 5 is a view showing a broadcast receiving apparatus according to an exemplary embodiment of the present invention. FIG. 6 is a view showing a broadcast receiving method according to an exemplary embodiment of the present invention.

Referring to FIG. 5, the broadcasting receiving apparatus 500 includes a demodulator 510, a demultiplexer 520, a video decoder 530, and an audio decoder 540.

As shown in FIG. 6, the demodulator 510 demodulates a received broadcast signal into a reception bit string (S610). The demodulator 510 can demodulate a received broadcast signal by a demodulation scheme corresponding to the modulation scheme of the modulator 150. In this case, an audio bit string can be demodulated properly even when the reception environment is not good, because the broadcasting transmitting apparatus allocates the audio bit string to bits with low error probability.

The demultiplexer 520 demultiplexes the reception bit string into a video bit string and an audio bit string (S620). The video bit string and the audio bit string are respectively input into the video encoder 530 and the audio encoder 540.

The video decoder 530 decodes the video bit string and reproduces it (S630).

The audio decoder 540 decodes the audio bit string and reproduces it (S640.

According to an embodiment of the present invention, audio signals with low error probability can be properly received even when it is difficult to properly view the broadcast because the intensity of a received signal decreases while viewing the broadcast, thereby enabling continuous broadcast reception.

An exemplary embodiment of the present invention may not only be embodied through the above-described apparatus and method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A broadcast transmitting method for a broadcast transmitting apparatus, the method comprising:
splitting a piece of broadcast content into an audio signal and a video signal;
encoding the audio signal and the video signal to generate an audio bit string and a video bit string;
multiplexing the video bit string and the audio bit string; and
modulating the multiplexed bit strings into a symbol,
wherein some bits of the symbol comprise the audio bit string, and the remaining bits of the symbol comprise the video bit string.

2. The method of claim 1, wherein the some bits comprise the most significant bit and at least one bit after the most significant bit.

3. The method of claim 1, wherein a signal allocated to each bit in the symbol is determined depending on the characteristics of the symbol.

4. The method of claim 3, wherein the characteristics comprise error probability.

5. The method of claim 1, wherein the encoding comprises encoding the audio bit string at a lower encoding rate than that of the video bit string.

6. A broadcasting transmitting apparatus comprising:
a splitter that splits a piece of broadcast content into an audio signal and a video signal;
an audio encoder that encodes the audio signal to generate an audio bit string;
a video encoder that encodes the video signal to generate a video bit string;
a multiplexer that multiplexes the audio bit string and the video bit string; and
a modulator that modulates the multiplexed bit strings into a symbol,
wherein the modulator allocates the encoded audio bit string to some bits of the symbol and allocates the encoded audio bit string to the remaining bits of the symbol.

7. The apparatus of claim 6, wherein the some bits comprise the most significant bit, and the remaining bits comprise the least significant bit.

8. The apparatus of claim 6, wherein the some bits have lower error probability than the remaining bits.

9. The apparatus of claim 6, wherein the audio encoder encodes the audio signal at a lower encoding rate than that for the video encoder.
